(19) United States
(12) Patent Application Publication
(10) Pub. No.: US 2025/0370210 A1
(43) Pub. Date: Dec. 4, 2025

(54) LENS UNIT

(71) Applicant: NIDEC INSTRUMENTS CORPORATION, Nagano (JP)

(72) Inventor: Tomoaki NAKAJIMA, Nagano (JP)

(73) Assignee: NIDEC INSTRUMENTS CORPORATION, Nagano (JP)

(21) Appl. No.: 18/875,155

(22) PCT Filed: Jun. 13, 2023
(86) PCT No.: PCT/JP2023/021926

§ 371 Date: Dec. 15, 2024

(30) Foreign Application Priority Data
Jun. 20, 2022 (JP) 2022-099258

(51) Int. Cl. G02B 7/02; G02B 7/00

(52) U.S. Cl. CPC G02B 7/021; G02B 7/006

(57) ABSTRACT

A lens unit is provided which includes a lens, an optical filter which is a filter in a flat plate shape, and a lens holder which holds the lens and the optical filter. The optical filter is disposed on an end face on one side in an optical axis direction of the lens holder, the end face is provided with an opening part where a lens face of the lens is exposed and a mounting surface which is a flat face part supporting the optical filter, the mounting surface is filled with an adhesive on a lateral side of a side face of the optical filter so that the adhesive adheres to the side face, and a step part forming a gap space between a plate face of the optical filter and the end face is provided between the opening part of the end face and the mounting surface.

### TECHNICAL FIELD

The present invention relates to a lens unit, and especially, relates to a fixing structure of an optical filter to a lens holder.

### BACKGROUND ART

In the following Patent Literature 1, a lens unit is disclosed in which an optical filter is fixed by heating and pressurizing and plastically deforming a claw part made of resin. In the following Patent Literature 2, a lens unit is disclosed in which a glass lens is fixed by a similar claw part and an adhesive. In the following Patent Literature 3, a lens unit is disclosed in which an optical filter is fixed by an adhesive and a groove is provided for connecting an inside of a lens barrel with outer air.

### CITATION LIST

### Patent Literature

Patent Literature 1: Japanese Patent Laid-Open No. 2018-54735

Patent Literature 2: Japanese Patent Laid-Open No. 2019-179076

Patent Literature 3: Japanese Patent Laid-Open No. 2015-31926

### SUMMARY OF THE INVENTION

### Problems to be Solved by the Invention

An accommodation space in a lens holder or the like where an optical filter is provided naturally requires a clearance for providing the optical filter. In a case that the optical filter is fixed only by a claw part described in the above-mentioned Patent Literatures, the optical filter is not fixed completely and thus, the optical filter may rattle in a range of a clearance due to vibration of the lens unit and the like. On the other hand, in a case that an optical filter is fixed by an adhesive, when the adhesive adheres to a lens, optical performance of the lens unit may be degraded.

In view of the problem described above, an objective of the present invention is to provide a lens unit in which an optical filter of the lens unit is capable of being fixed safely by an adhesive.

### Means to solve the Problems

To solve the above-mentioned problem, the present invention provides a lens unit including a lens, an optical filter which is a filter in a flat plate shape, and a lens holder which holds the lens and the optical filter. The optical filter is disposed on an end face on one side in an optical axis direction of the lens holder, the end face is provided with an opening part where a lens face of the lens is exposed and a mounting surface which is a flat face part supporting the optical filter, the mounting surface is filled with an adhesive on a lateral side of a side face of the optical filter so as to adhere to the side face, and a step part forming a gap space between a plate face of the optical filter and the end face is provided between the opening part of the end face and the mounting surface.

An adhesive is filled on a lateral side of an optical filter and adheres to a side face of the optical filter and thus, movement of the optical filter to the lateral side is prevented by the solidified adhesive. In other words, a clearance provided in a placing space of the optical filter can be eliminated after the optical filter is placed. Further, although the adhesive infiltrates between a plate face of the optical filter and a mounting surface by capillary force, the capillary force is interrupted by a step part and oozed adhesive is held by the step part. As a result, the adhesive is prevented from adhering to a lens and the optical filter can be safely fixed by the adhesive.

In this case, it may be structured that a periphery of the opening part in the end face is provided with a slope face in a ring shape which is inclined downward toward the opening part, and the step part is provided between the slope face and the mounting surface. When a dedicated step part is provided for interrupting capillary force between the plate face of the optical filter and the mounting surface and for holding the oozed adhesive, the lens can be further surely protected from the adhesive.

Further, in the lens unit in the present invention, it is preferable that the end face is provided with a claw part preventing floating of the optical filter and, after the optical filter is disposed, the claw part is bent to the optical filter side by heating and pressurizing and is engaged with its edge part. The optical filter is fixed by both of the adhesive and the claw part and thus, falling of the optical filter can be further surely prevented.

Further, it is preferable that the optical filter is a filter whose plate face is in a rectangular shape, and the adhesive adheres to two side faces structuring one of four corners of the optical filter. According to this structure, movement of the optical filter on the mounting surface in the “X-Y” direction (two directions perpendicular to each other which are parallel to the mounting surface) is restricted and rattling of the optical filter can be effectively suppressed.

In this case, it is preferable that the adhesive adheres to respective side faces structuring the four corners of the optical filter. This is because rattling of the optical filter is further surely suppressed.

Further, it is preferable that the mounting surface is formed so that its face position is lower in a step shape than an outer edge part of the end face, the mounting surface is provided with an expanded part which is formed in a range that the optical filter does not reach, and a step surface between the expanded part and the outer edge part and a side face of the optical filter form an adhesive reservoir which is a recessed space in which the adhesive is held. According to this structure, filling work of the adhesive becomes easy, working quality is stable, and a sufficient amount of the adhesive for restricting movement to a lateral side of the optical filter can be filled.

Further, in the lens unit in the present invention, it is preferable that the end face is formed with an air groove which is a groove for connecting the opening part with outer air, and the air groove is extended from an inner side with respect to a peripheral edge of the optical filter to an outer side with respect to the optical filter in a plan view of the end face. In a case that the lens holder is sealed by the optical filter, a method for inspecting airtightness becomes complicated, and outgas of the adhesive may degrade optical performance of a lens. When the air groove is provided, the above-mentioned problem can be eliminated.

In this case, it is preferable that the lens unit is an injection molded component, and a pin mark of a metal mold is formed in a portion of the air groove on an outer side with respect to the optical filter. An ejector pin is contacted with the air groove which is only an air passage and thus, even when a burr is formed when taken out, the influence is suppressed. Further, in this case, it is preferable that a portion where the pin mark is formed is formed thicker than another portion of the air groove. This is because component strength of the lens holder is not reduced.

Further, it is preferable that the step part is provided with a plurality of steps whose face positions become stepwise lower toward a side of the opening part. This is because the adhesive is further surely prevented from adhering to a lens.

Further, it is preferable that the adhesive has an ultraviolet-curing property and a moisture-curing property. The adhesive has an ultraviolet-curing property and thus, time required to solidify the adhesive can be shortened. On the other hand, in the adhesive infiltrated between the optical filter and the mounting surface, there is a possibility that the ultraviolet rays do not reach sufficiently. In order to prevent this problem, the adhesive also has a moisture-curing property and thus, a portion which is not solidified by ultraviolet rays can be solidified with a lapse of time.

Further, the lens unit in the present invention may be structured so that the lens includes a plurality of lenses arranged in the optical axis direction, the optical filter is a filter whose plate face is in a rectangular shape, the mounting surface is provided at positions corresponding to four corners of the optical filter, the adhesive adheres to respective side faces structuring the four corners of the optical filter, the end face is provided with a plurality of claw parts preventing floating of the optical filter which is placed on the respective mounting parts, each of the claw parts is bent to the optical filter side by heating and pressurizing and is engaged with an edge part of the optical filter after the optical filter is disposed, the end face is formed with a plurality of air grooves which are grooves connecting the opening part with outer air, each of the air grooves is extended from an inner side with respect to a peripheral edge of the optical filter to an outer side with respect to the optical filter in a plan view of the end face, and the air grooves are respectively provided between the mounting surfaces adjacent to each other.

### Effects of the Invention

As described above, according to the lens unit in the present invention, a harmful effect when the optical filter is fixed to the lens holder by the adhesive can be reduced.

### BRIEF DESCRIPTION OF THE DRAWINGS

FIG. 1 is a cross-sectional side view showing an internal structure of a lens unit in this embodiment.

FIG. 2 is a plan view showing an image side end face of the lens unit.

In FIG. 3, (a) is a partial enlarged view showing a portion surrounded by a one-dot chain line in FIG. 2, and (b) is a perspective view showing the portion.

In FIG. 4, (a) is a partial enlarged view showing a state before an infrared cut filter is disposed in the portion shown in (a) and (b) of FIG. 3, and (b) is its perspective view.

FIG. 5 is the “N-N” cross-sectional view showing an image side end face in (a) of FIG. 3.

FIG. 6 is the “M-M” cross-sectional view showing an image side end face in (a) of FIG. 3.

### DESCRIPTION OF EMBODIMENTS

A lens unit in accordance with an embodiment of the present invention will be described below with reference to the accompanying drawings. A lens unit 90 in this embodiment is a general-purpose small lens unit which is used for various imaging devices.

The lens unit 90 in this embodiment has a feature which is a fixing structure of an optical filter to a lens holder. Specifically, the lens unit 90 is structured so that an optical filter in a flat plate shape and a lens holder are chemically joined to each other by an adhesive and, in addition, the solidified adhesive is adjacently disposed to a side face of the optical filter and thereby, a clearance in a placing space of the optical filter is eliminated afterward and rattling of the optical filter is structurally prevented. Further, an end face of the lens holder on which the optical filter is placed is provided with a dedicated gap space (step part) for preventing the adhesive infiltrated by capillary force from adhering to a lens and thereby, a harmful effect of using an adhesive for fixing an optical lens is reduced. Next, the feature and its collateral feature are specifically described below.

### Entire Structure

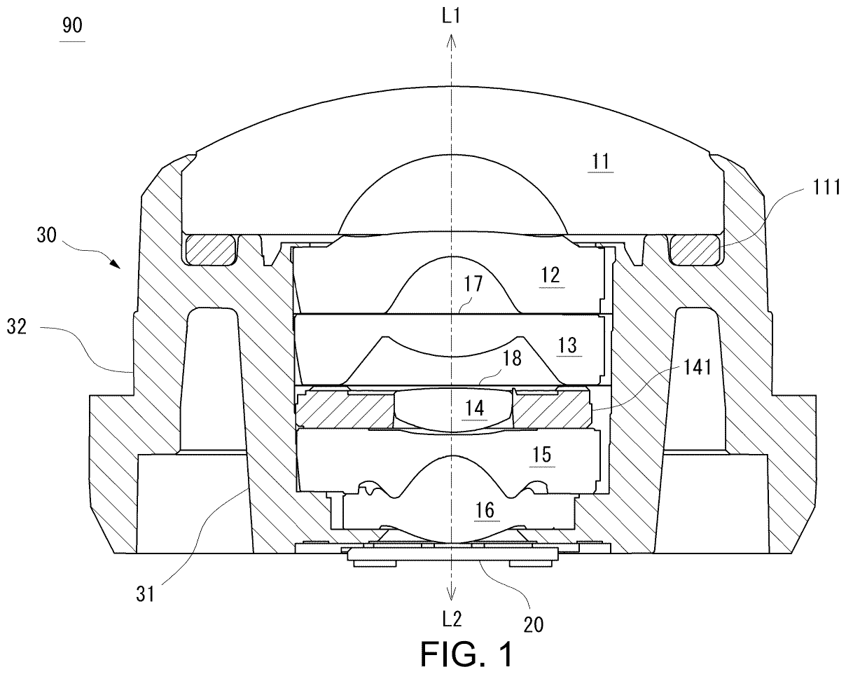

FIG. 1 is a cross-sectional side view showing an internal structure of a lens unit 90 in this embodiment. Next, an entire structure of the lens unit 90 will be described below with reference to FIG. 1.

The one-dot chain line “L1-L2” shown in FIG. 1 shows an optical axis of the lens unit 90, and the “L1” side is an object side (subject side) and the “L2” side is an image side. The lens unit 90 includes six lenses, i.e., a first lens 11 through a sixth lens 16, which are arranged along the optical axis “L1-L2”, and a lens holder 30 which holds the lenses. A light shielding plate 17 is disposed between the second lens 12 and the third lens 13, and a diaphragm 18 is disposed between the third lens 13 and the fourth lens 14. Further, an end face on the most image side of the lens holder 30 is disposed with an infrared cut filter 20 which is an optical filter (hereinafter, referred to as an “IRCF 20”).

Among these lenses, the first lens 11 located on the most object side and the fourth lens 14 are glass lenses. The fourth lens 14 is supported by the lens holder 30 in a state that the fourth lens 14 is held by a holder 141 which is a frame body in a circular ring shape. The second lens 12, the third lens 13, the fifth lens 15 and the sixth lens 16 are plastic lenses. The sixth lens located on the most image side and the fifth lens 15 structure a cemented lens. In this embodiment, the number and types of the lenses held by the lens holder 30 are not limited to a structure in this embodiment and can be appropriately changed according to a use of the lens unit and a subject.

The lens holder 30 in this embodiment is a lens barrel or a lens frame in a double barrel structure which is structured of an inner barrel 31 and an outer barrel 32. The first lens 11 is supported by the outer barrel 32 of the lens holder 30, and other lenses, the light shielding plate 17 and the diaphragm 18 are accommodated in the inner barrel 32. The structure of the lens holder 30 is not limited to that in this embodiment, and a lens holder having any structure may be used when an optical filter is disposed at one end in the optical axis direction.

### IRCF Fixing Structure

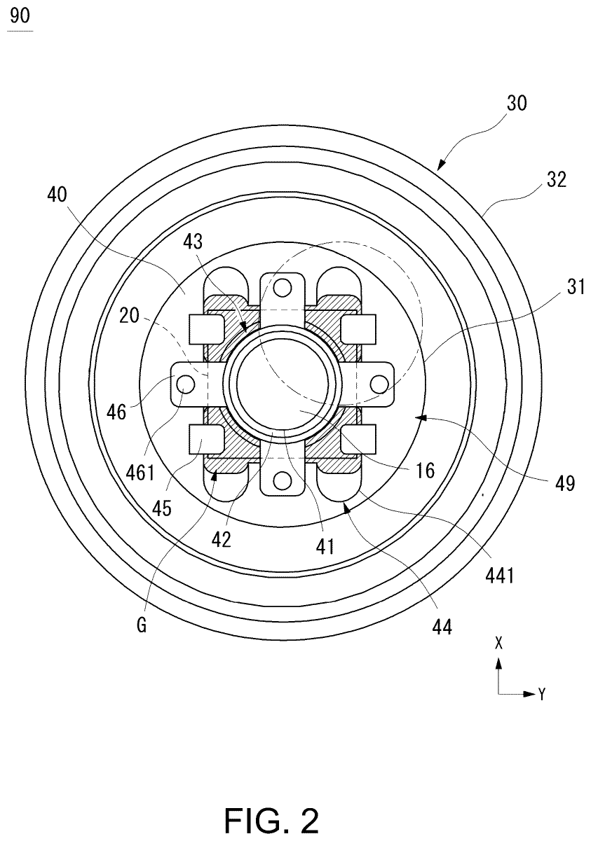

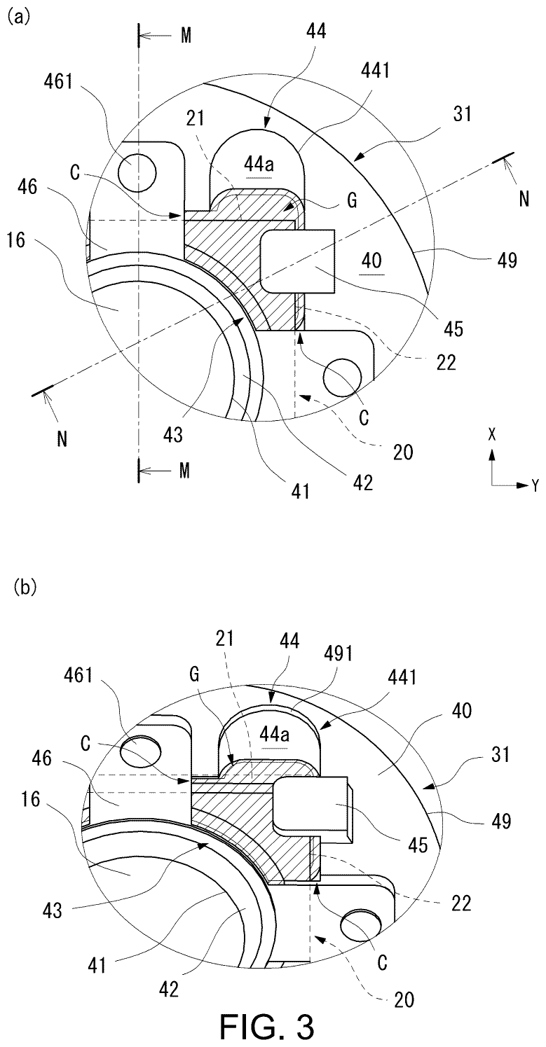

FIG. 2 is a plan view showing an end face on an image side (hereinafter, referred to as an “image side end face 40”) of the lens unit 90. In FIG. 3, (a) is a partial enlarged view showing a portion surrounded by the one-dot chain line in FIG. 2, and (b) is a perspective view showing the portion. In FIG. 4, (a) is a partial enlarged view showing a state before an ICRF 20 is disposed in the portion shown in (a) and (b) of FIG. 3, and (b) is its perspective view. Next, a fixing structure of the IRCF 20 will be described below with reference to FIG. 2 through FIG. 4.

As described above, the IRCF 20 is disposed on an image side end face 40 of the lens holder 30. The IRCF 20 is an optical filter in a flat plate shape having a square plate face. As shown in FIG. 2 through FIG. 4, the image side end face 40 is provided with mounting surfaces 44 on which four corners of the IRCF 20 are placed. FIG. 3 and FIG. 4 are enlarged views showing a portion corresponding to one of the four corners of the IRCF 20, and a fixing structure describe below is common to all of the four corners of the IRCF 20.

The mounting surface 44 is a flat face part which is formed so that its face position is lower in a step shape than an outer edge part 49 of the image side end face 40. A center of the image side end face 40 is formed with an opening part 41 through which a lens face of the sixth lens 16 is exposed, and a ring-shaped slope face 42 which inclines downwardly toward the opening part 41 is provided around the opening part 41. A step part 43 described below is provided between the slope face 42 and the mounting surface 44.

The IRCF 20 in this embodiment is fixed to the mounting surface 44 by an adhesive “G” and claw parts 45 described below. In FIG. 2 and FIG. 3, for convenience of explanation, the adhesive “G” is hatched to clearly indicate its coating range. As shown in (b) of FIG. 3, the adhesive “G” is filled on lateral sides of the side faces 21 and 22 which structure the four corners of the IRCF 20 on the mounting surface 44 so as to adhere to the side faces 21 and 22 in the “X” and “Y” directions (two directions horizontally perpendicular to each other). The adhesive “G” infiltrates into between a plate face of the IRCF 20 and the mounting surface 44 by capillary force, and the adhesive “G” oozed from the mounting surface 44 to the opening part 41 side is held by the step part 43.

A space of the image side end face 40 where the IRCF 20 is placed requires a clearance “C” ((a) of FIG. 3) for placing the IRCF 20 naturally. In the lens unit 90 in this embodiment, the adhesive “G” is filled on a lateral side of the IRCF 20 and adheres to the side faces 21 and 22 in the “X” and “Y” directions of the IRCF 20 and thereby, movement of the IRCF 20 to the lateral side is prevented by the solidified adhesive “G”. In other words, the clearance “C” provided in a placing space of the IRCF 20 is eliminated after the IRCF 20 is mounted and, as a result, rattling of the IRCF 20 is prevented. Especially, in this embodiment, the solidified adhesive “G” is provided on lateral sides of all the side faces which structure four corners of the IRCF 20 and thus, a suppression effect of rattling is maximized.

As shown in FIG. 3, the mounting surface 44 is provided with an expanded part 441 which is expanded in a range that the IRCF 20 does not reach, and a step surface 491 between the expanded part 441 and the outer edge part 49 and the “X”-side side face 21 of the IRCF 20 forms an adhesive reservoir 44a which is a space in a recessed shape where the adhesive “G” is held. As a result, filling work of the adhesive “G” is easily performed and working quality is stable. Further, a sufficient amount of the adhesive can be filled for preventing movement of the IRCF 20 to a lateral side.

The adhesive reservoir 44a in this embodiment is formed so as to protrude in a tongue piece shape to the “X”-direction side with respect to the IRCF 20 as shown in (a) of FIG. 3. In this embodiment, the claw part 45 is provided on the “Y”-direction side of the mounting surface 44 and thus, the above-mentioned structure is employed. However, the adhesive reservoir 44a may be provided on the “Y”-direction side with respect to the IRCF 20, or both of the “X”-direction side and the “Y”-direction side. In addition, when there is no problem in filling work and filling amount of the adhesive “G”, no adhesive reservoir 44a may be provided. In this case, the adhesive “G” is only filled to the clearance “C” of the mounting surface 44.

The adhesive “G” in this embodiment has an ultraviolet-curing property and a moisture-curing property. The adhesive “G” has an ultraviolet-curing property and thus, a time required for solidifying the adhesive “G” is shortened. On the other hand, in the adhesive “G” infiltrated between the IRCF 20 and the mounting surface 44, when ultraviolet rays are reflected and attenuated by the IRCF 20, there is a possibility that the ultraviolet rays do not reach sufficiently. In order to prevent this problem, the adhesive “G” further has a moisture-curing property and thus, a portion which is not solidified by ultraviolet rays can be solidified with a lapse of time. Further, although described in detail later, the image side end face 40 is provided with air grooves 46 for connecting the opening part 41 with outer air, and moisture of the outer air affects the adhesive “G” oozed from the mounting surface 44 such as the adhesive “G” held by the step part 43.

Further, the image side end face 40 in this embodiment has claw parts 45 which prevent floating of the IRCF 20. As shown in FIG. 4 and FIG. 3, the claw part 45 is bent to the IRCF 20 side by heating and pressurizing after the IRCF 20 is placed, and the claw part 45 is engaged with the edge part. Falling of the IRCF 20 is further surely prevented by fixing the IRCF 20 by both of the adhesive “G” and the claw part 45. In accordance with an embodiment of the present invention, in a case that the adhesive “G” has sufficient bonding strength or, in a case that the lens unit 90 is used in a stationary (without vibration) environment, the claw part 45 may be omitted.

### Structure of Step Part

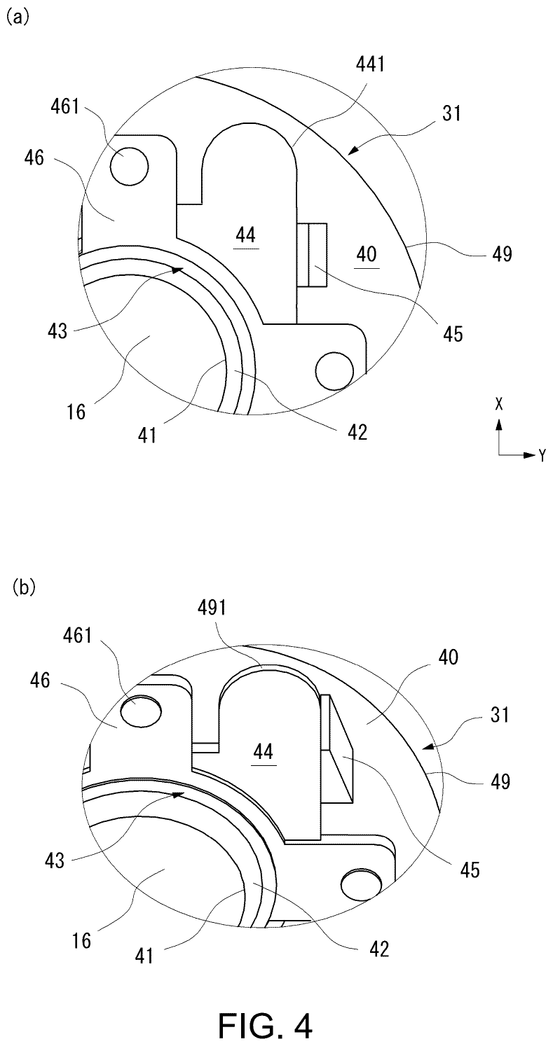

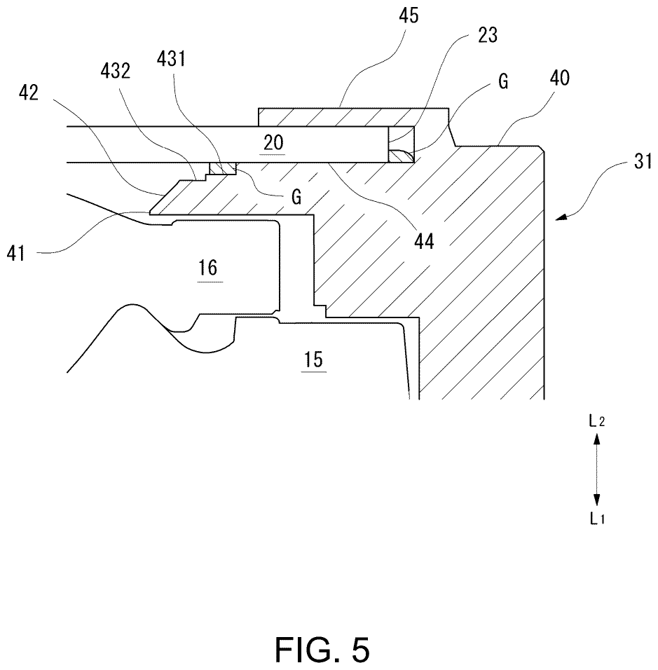

FIG. 5 is the “N-N” cross-sectional schematic view showing the image side end face 40 in (a) of FIG. 3. Next, a structure of the step part 43 will be described below with reference to FIG. 3 through FIG. 5.

As shown in FIG. 5, the step part 43 which forms a gap space between a plate face of the IRCF 20 and the image side end face 40 is provided between the slope face 42 of the image side end face 40 and the mounting surface 44. The step part 43 in this embodiment is structured of a first step part 431 and a second step part 432 which are two-stage steps whose face positions become lower stepwise as going from the mounting surface 44 side to the slope face 42 side (opening part 41 side).

The adhesive “G” infiltrates between the plate face of the IRCF 20 and the mounting surface 44 by capillary force. In a case that the adhesive “G” oozes to the opening part 41 side, the adhesive “G” may adhere to the sixth lens 16 to degrade optical performance of the lens unit 90. The lens holder 30 in this embodiment is provided with the step part 43 (first step part 431 and second step part 432) and thus, the capillary force is interrupted by the step part 43 and the oozed adhesive “G” is held by the step part 43. As a result, the adhesive “G” is prevented from adhering to the lens and the IRCF 20 can be safely fixed by the adhesive “G”.

Even in a case that the step part 43 is not provided, when the slope face 42 is provided, a gap space is formed by the slope face 42 between the plate face of the IRCF 20 and the image side end face 40. Therefore, it may be expected that the capillary force is interrupted and infiltration of the adhesive “G” is stopped. On the other hand, the step part 43 is formed stepwise, and a step face (upper face) of each step is a flat face. When the adhesive “G” is to be filled and cured, the step faces are disposed horizontally. In addition, the adhesive “G” is pulled by surface tension toward a bottom end of each step (in other words, a rear end of a step face of each step). As described above, the lens unit 90 is provided with the step part 43 and thus, in comparison with a lens unit having a structure that the adhesive “G” directly flows into the slope face 42, an effect keeping away the adhesive “G” from the opening part 41 is enhanced. In this embodiment, the second step part 432 is a preliminary step part, and the effect of the step part 43 can be obtained only with the first step part 431.

### Structure of Air Groove

The lens holder 30 is provided on the image side end face 40 with a plurality of air grooves 46, i.e., four grooves which connect the opening part 41 with outer air. The air groove is extended from an inner side with respect to a peripheral edge of the IRCF 20 to an outer side with respect to the IRCF 20 and is provided at each position between the mounting surfaces 44 adjacent to each other. In a case that the lens holder 30 is sealed by the IRCF 20, a method for inspecting airtightness becomes complicated, and outgas of the adhesive “G” and another adhesive used in an inside of the lens holder 30 may degrade optical performance of the lens. The lens unit 90 is provided with the air grooves 46 and thus, the above-mentioned problem is eliminated.

Further, the air groove 46 in this embodiment has an effect of interrupting the capillary force between the plate face of the IRCF 20 and the mounting surface 44. The second step part 432 in this embodiment is formed in a ring shape so as to surround the entire circumference of the slope face 42 and functions as a preliminary step part for the adhesive “G” entered into the air groove 46.

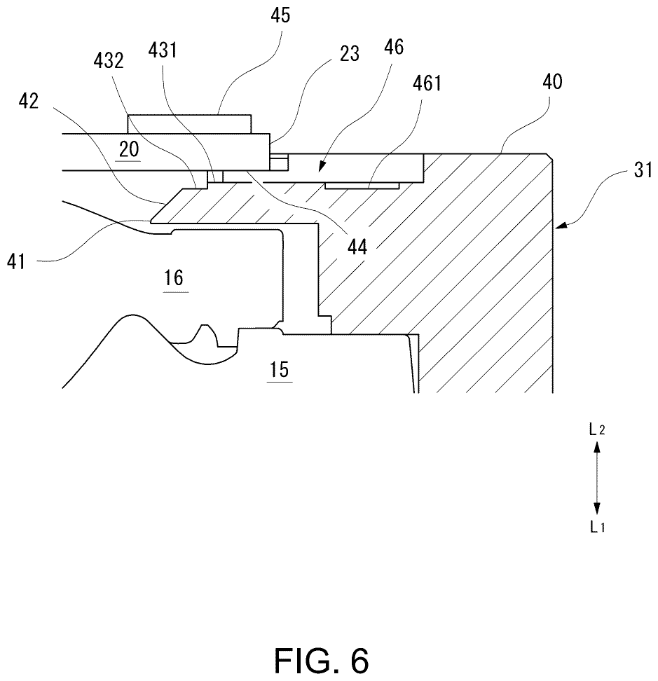

FIG. 6 is the “M-M” cross-sectional schematic view showing the image side end face in (a) of FIG. 3. The lens unit 90 in this embodiment is an injection molded component, and a pin mark of a metal mold is formed in a portion of each of the air grooves 46 on an outer side with respect to the IRCF 20. An ejector pin is contacted with the air groove 46 which is only an air passage and thus, even when a burr is formed when taken out, the influence is suppressed. Further, as shown in FIG. 6, a portion where the pin mark is formed is formed thicker than another portion of the air groove 46. As a result, component strength of the lens holder 30 is maintained.

The embodiments of the present invention may be structured as follows.

(1) A lens unit including a lens, an optical filter which is a filter in a flat plate shape, and a lens holder holding the lens and the optical filter, where the optical filter is disposed on one end face in an optical axis direction of the lens holder, the end face has an opening part where a lens face of the lens is exposed and a mounting surface which is a flat face part supporting the optical filter, the mounting surface is filled with an adhesive on a lateral side of a side face of the optical filter so that the adhesive adheres to the side face, and a step part forming a gap space between a plate face of the optical filter and the end face is provided between the opening part of the one end face and the mounting surface.

(2) The lens unit described in the above-mentioned structure (1), where a periphery of the opening part in the end face is provided with a ring-shaped slope face which is inclined downward toward the opening part, and the step part is provided between the slope face and the mounting surface.

(3) The lens unit described in the above-mentioned structure (1) or (2), where the end face has a claw part preventing floating of the optical filter, and the claw part is bent to the optical filter side by heating and pressurizing and is engaged with its edge part after the optical filter is disposed.

(4) The lens unit described in one of the above-mentioned structures (1) through (3), where the optical filter is a filter whose plate face is in a rectangular shape, and the adhesive adheres to two side faces structuring one of four corners of the optical filter.

(5) The lens unit described in the above-mentioned structure (4), where the adhesive adheres to respective side faces structuring the four corners of the optical filter.

(6) The lens unit described in one of the above-mentioned structures (1) through (5), where the mounting surface is formed so that its face position is lower in a step shape than an outer edge part of the end face, the mounting surface is provided with an expanded part which is formed in a range that the optical filter does not reach, and a step surface between the expanded part and the outer edge part and a side face of the optical filter form an adhesive reservoir which is a recessed space in which the adhesive is held.

(7) The lens unit described in one of the above-mentioned structures (1) through (6), where the end face is formed with an air groove which is a groove for connecting the opening part with outer air, and the air groove is extended from an inner side with respect to a peripheral edge of the optical filter to an outer side with respect to the optical filter in a plan view of the end face.

(8) The lens unit described in the above-mentioned structure (7), where the lens unit is an injection molded component, and a pin mark of a metal mold is formed in a portion of the air groove on an outer side with respect to the optical filter.

(9) The lens unit described in the above-mentioned structure (8), where the portion where the pin mark is formed is formed thicker than another portion of the air groove.

(10) The lens unit described in one of the above-mentioned structures (1) through (9), where the step part has a plurality of steps whose face positions become stepwise lower toward the opening part side.

(11) The lens unit described in one of the above-mentioned structures (1) through (10), where the adhesive has an ultraviolet-curing property and a moisture-curing property.

(12) The lens unit described in one of the above-mentioned structures (1) through (11), where the lens includes a plurality of lenses arranged in the optical axis direction, the optical filter is a filter whose plate face is in a rectangular shape, the mounting surface is provided at positions corresponding to four corners of the optical filter, the adhesive adheres to respective side faces structuring the four corners of the optical filter, the end face is provided with a plurality of claw parts preventing floating of the optical filter which is placed on the respective mounting parts, each of the claw parts is bent to the optical filter side by heating and pressurizing and is engaged with its edge part after the optical filter is disposed, the end face is formed with a plurality of air grooves which are grooves connecting the opening part with outer air, each of the air grooves is extended from an inner side with respect to a peripheral edge of the optical filter to an outer side with respect to the optical filter in a plan view of the end face, and the air grooves are respectively provided between the mounting surfaces adjacent to each other.

Although the present invention has been shown and described with reference to a specific embodiment, the present invention is not limited to the above-mentioned embodiment and various changes and modifications will be apparent to those skilled in the art from the teachings herein. For example, in the embodiment described above, the IRCF 20 is employed as an optical filter. However, the optical filter may be other optical filters. Further, a plate face shape of the IRCF 20 is a square, but the plate face shape may be a circle.

### REFERENCE SIGNS LIST

90: lens unit, 16: sixth lens (lens), 20: infrared cut filter (IRCF) (optical filter), 21: “X”-side face, 22: “Y”-side face, 30: lens holder, 31: inner barrel, 32: outer barrel, 40: image side end face (end face), 41: opening part, 42: slope face, 43: step part, 431: first step part, 432: second step part, 44: mounting surface, 441: expanded part, 45: claw part, 46: air groove, 461: pin mark, 49: outer edge part, 491: step surface, “G”: adhesive

1. A lens unit comprising:
a lens;
an optical filter which is a filter in a flat plate shape; and
a lens holder which holds the lens and the optical filter;
wherein the optical filter is disposed on an end face on one side in an optical axis direction of the lens holder;
the end face comprises:
an opening part where a lens face of the lens is exposed, and
a mounting surface which is a flat face part supporting the optical filter;
the mounting surface is filled with an adhesive on a lateral side of a side face of the optical filter so that the adhesive adheres to the side face; and
a step part forming a gap space between a plate face of the optical filter and the end face is provided between the opening part of the end face and the mounting surface.

2. The lens unit according to claim 1, wherein
a periphery of the opening part in the end face is provided with a slope face in a ring shape which is inclined downward toward the opening part, and
the step part is provided between the slope face and the mounting surface.

3. The lens unit according to claim 1, wherein
the end face comprises a claw part preventing floating of the optical filter, and
the claw part is bent to a side of the optical filter by heating and pressurizing and is engaged with an edge part of the optical filter after the optical filter is disposed.

4. The lens unit according to claim 1, wherein
the optical filter is a filter whose plate face is in a rectangular shape, and
the adhesive adheres to two side faces structuring one of four corners of the optical filter.

5. The lens unit according to claim 4, wherein
the adhesive adheres to respective side faces structuring the four corners of the optical filter.

6. The lens unit according to claim 1, wherein
the mounting surface is formed so that its face position is lower in a step shape than an outer edge part of the end face,
the mounting surface comprises an expanded part which is formed in a range that the optical filter does not reach, and
a step surface between the expanded part and the outer edge part and a side face of the optical filter form an adhesive reservoir which is a recessed space in which the adhesive is held.

7. The lens unit according to claim 1, wherein
the end face is formed with an air groove which is a groove for connecting the opening part with outer air, and
the air groove is extended from an inner side with respect to a peripheral edge of the optical filter to an outer side with respect to the optical filter in a plan view of the end face.

8. The lens unit according to claim 7, wherein
the lens unit is an injection molded component, and
a pin mark of a metal mold is formed in a portion of the air groove on an outer side with respect to the optical filter.

9. The lens unit according to claim 8, wherein
the portion where the pin mark is formed is formed thicker than another portion of the air groove.

10. The lens unit according to claim 1, wherein
the step part comprises a plurality of steps whose face positions become stepwise lower toward a side of the opening part.

11. The lens unit according to claim 1, wherein
the adhesive has an ultraviolet-curing property and a moisture-curing property.

12. The lens unit according to claim 1, wherein
the lens comprises a plurality of lenses arranged in the optical axis direction,
the optical filter is a filter whose plate face is in a rectangular shape,
the mounting surface is provided at positions corresponding to four corners of the optical filter,
the adhesive adheres to respective side faces structuring the four corners of the optical filter,
the end face is provided with a plurality of claw parts preventing floating of the optical filter which is placed on the respective mounting surfaces,
each of the claw parts is bent to a side of the optical filter by heating and pressurizing and is engaged with an edge part of the optical filter after the optical filter is disposed,
the end face is formed with a plurality of air grooves which are grooves connecting the opening part with outer air,
each of the air grooves is extended from an inner side with respect to a peripheral edge of the optical filter to an outer side with respect to the optical filter in a plan view of the end face, and
the air grooves are respectively provided between the mounting surfaces adjacent to each other.

13. The lens unit according to claim 2, wherein
the end face comprises a claw part preventing floating of the optical filter, and
the claw part is bent to a side of the optical filter by heating and pressurizing and is engaged with an edge part of the optical filter after the optical filter is disposed.

14. The lens unit according to claim 13, wherein
the optical filter is a filter whose plate face is in a rectangular shape, and
the adhesive adheres to two side faces structuring one of four corners of the optical filter

15. The lens unit according to claim 14, wherein
the adhesive adheres to respective side faces structuring the four corners of the optical filter.

16. The lens unit according to claim 15, wherein
the mounting surface is formed so that its face position is lower in a step shape than an outer edge part of the end face,
the mounting surface comprises an expanded part which is formed in a range that the optical filter does not reach, and
a step surface between the expanded part and the outer edge part and a side face of the optical filter form an adhesive reservoir which is a recessed space in which the adhesive is held.

17. The lens unit according to claim 16, wherein
the end face is formed with an air groove which is a groove for connecting the opening part with outer air, and
the air groove is extended from an inner side with respect to a peripheral edge of the optical filter to an outer side with respect to the optical filter in a plan view of the end face.

18. The lens unit according to claim 17, wherein
the lens unit is an injection molded component, and
a pin mark of a metal mold is formed in a portion of the air groove on an outer side with respect to the optical filter.

19. The lens unit according to claim 18, wherein
the portion where the pin mark is formed is formed thicker than another portion of the air groove.

20. The lens unit according to claim 19, wherein
the step part comprises a plurality of steps whose face positions become stepwise lower toward a side of the opening part.
